(19) United States
(12) Patent Application Publication
(10) Pub. No.: US 2022/0298372 A1
(43) Pub. Date: Sep. 22, 2022

(54) INK, INK SET, PRINTED MATTER, PRINTING METHOD, AND PRINTING APPARATUS

(71) Applicants: Naoto Shimura, Tokyo (JP); Masaki Kudo, Kanagawa (JP)

(72) Inventors: Naoto Shimura, Tokyo (JP); Masaki Kudo, Kanagawa (JP)

(73) Assignee: Ricoh Company, Ltd., Tokyo (JP)

(21) Appl. No.: 17/641,758

(22) PCT Filed: Jul. 1, 2020
(86) PCT No.: PCT/JP2020/025877

§ 371 Date: Mar. 9, 2022

(30) Foreign Application Priority Data
Sep. 20, 2019 (JP) 2019-171334

(51) Int. Cl. C09D 11/40; C09D 11/322; C09D 11/36; C09D 11/037; C09D 11/033; C09D 11/102; C09D 11/107; D06P 5/30; D06P 1/52; D06P 1/673; B41M 5/00; B41M 7/00

(52) U.S. Cl. CPC C09D 11/40; C09D 11/322; C09D 11/36; C09D 11/037; C09D 11/033; C09D 11/102; C09D 11/107; D06P 5/30; D06P 1/5285; D06P 1/525; D06P 1/673; B41M 5/0023; B41M 7/0036; B41M 5/0076

(57) ABSTRACT

An ink used for printing on a leather includes: a coloring material, an organic solvent, and a resin; where a maximum tensile stress of an ink film formed of the ink is 2 N/mm² or more.

### TECHNICAL FIELD

The present disclosure relates to an ink, an ink set, a printed matter, a printing method, and a printing apparatus.

### BACKGROUND ART

Conventionally, the screen method and the inkjet method have been used for decoration onto a leather. Among them, the inkjet method has been increasingly used because it can decorate various designs, a process and formation of a full color image are easier than other recording methods, and an image having a high resolution can be obtained even when a device having a simple configuration is used.

In the inkjet method, an aqueous ink or solvent ink is used for a permeable leather such as a case leather. In addition, an ultraviolet ray curable ink (UV ink) is used for a wide variety of leathers (see, for example, PTLs 1 and 2).

Moreover, a latex ink, which enables decoration onto a wide variety of leathers and can form an ink film that is more flexible and safer than the UV ink, has been proposed (see, for example, PTL 3).

### CITATION LIST

### Patent Literature

PTL 1: Unexamined Japanese Patent Application Publication No. 2014-55210
PTL 2: WO2017/104318
PTL 3: Unexamined Japanese Patent Application Publication No. 2019-77070

### SUMMARY OF INVENTION

### Technical Problem

An object of the present disclosure is to provide an ink that is excellent in scratch resistance and can form an image without deteriorating texture such as softness or touch of a leather even when a leather is used as a matter to be printed.

### Solution to Problem

According to one aspect of the present disclosure, an ink used for a leather as a matter to be printed includes: a coloring material; an organic solvent; and a resin. A maximum tensile stress of an ink film formed of the ink is 2 N/mm² or more.

### Advantageous Effects of Invention

According to the present disclosure, it is possible to provide an ink that is excellent in scratch resistance and can form an image without deteriorating texture such as softness or touch of a leather even when a leather is used as a matter to be printed.

### BRIEF DESCRIPTION OF DRAWINGS

FIG. 1 is a perspective explanatory view illustrating one example of a printing apparatus.

FIG. 2 is a perspective explanatory view illustrating one example of a main tank of a printing apparatus.

### DESCRIPTION OF EMBODIMENTS

(Ink)

An ink of the present disclosure is an ink used for a leather as a matter to be printed, and includes: a coloring material; an organic solvent; and a resin. A maximum tensile stress of an ink film formed of the ink is 2 N/mm² or more. The ink of the present disclosure further includes other components if necessary.

Conventional aqueous inks and solvent inks have a problem that abnormal images such as color bleeding and beading are caused on a poorly permeable or impermeable leather surface of which is coated with, for example, a resin.

Conventional UV inks may possibly deteriorate texture such as softness or touch of a leather because a hard ink film is formed, and are problematic in terms of safety.

Conventional latex inks have a problem that an ink film formed on a leather is deteriorated in scratch resistance compared to an ink film formed of the UV ink.

Therefore, the conventional techniques have a problem that use of a leather as a matter to be printed decreases scratch resistance and deteriorates texture such as softness or touch of an original leather.

In the present disclosure, when an ink includes a coloring material, an organic solvent, and a resin and a maximum tensile stress of an ink film formed of the ink is controlled to 2 N/mm² or more, it is possible to increase the strength of the ink film formed on a leather and to form an image excellent in scratch resistance without deteriorating texture such as softness or touch of a leather.

A maximum tensile stress of an ink film formed of the ink is 2 N/mm² or more, preferably 5 N/mm² or more, more preferably 8 N/mm² or more.

When the maximum tensile stress of the ink film is 2 N/mm² or more, a printed matter excellent in scratch resistance can be obtained.

Here, the maximum tensile stress of ink film can be measured as follows. Ink (8 g) is added to a TEFLON (registered trademark) dish having a diameter of 50 mm and is dried in a hot-air-circulation-type thermostat bath at 70 degrees Celsius for two days, to obtain an ink film. The ink film obtained is cut into a piece having a size of 5 mm×50 mm using a cutter, and is subjected to the tensile testing under the following measurement conditions. An average thickness of the ink film, which is an average value obtained by measuring three or more portions with a micrometer, is from 0.3 mm through 0.8 mm.

<Measurement Conditions of Tensile Stress>

Device: AUTOGRAPH AG-10N, available from SHIMADZU CORPORATION

Load cell: 50 N

Tension speed: 150 mm/min

Distance between chucks: 4 mm

Sample width: 5 mm

<Matter to be Printed>

As the matter to be printed, a leather is used. There are a variety of leathers. Examples of the leather include: a natural leather produced from an animal skin; a synthetic leather that includes a woven fabric or knitted fabric as a base fabric and is coated with a synthetic resin; an artificial leather that is obtained by coating, with a synthetic resin, a base material obtained by impregnating a nonwoven fabric with a synthetic resin; and a recycled leather that is obtained by pulverizing cutting waste pieces generated in the production process of a natural leather, and solidifying the cutting waste pieces in the form of a sheet, followed by a surface coating processing. Generally, leathers are given various functions such as water resistance and heat resistance by various finishing methods, and have diverse surface formulations.

Examples of the leather include a permeable natural leather such as a case leather, an artificial leather, a synthetic leather, a recycled leather, a surface-treated natural leather, a surface-treated artificial leather, a surface-treated synthetic leather, and a surface-treated recycled leather.

Examples of the surface treatment subjected to the above surface-treated leathers include a treatment using, for example, a resin or an oil.

Examples of the resin include an acrylic resin, a urethane resin, and a vinyl chloride resin.

The natural leather is not particularly limited. It is possible to use leathers made from various animal skins such as cowhide, pigskin, sheepskin, and horsehide.

The artificial leather is not particularly limited. It is possible to use those that are obtained by coating, with a synthetic resin, a base material obtained by impregnating a nonwoven fabric formed of microfibers such as nylon or polyester with a synthetic resin, or a surface of the nonwoven fabric.

The synthetic leather is not particularly limited. It is possible to use those obtained by coating, with a synthetic resin, a surface of a base material of a woven fabric knitted fabric formed of, for example, natural fibers, nylon fibers, or polyester fibers.

A leather product made of the leather can be used in a wide variety of fields such as clothing, bags, shoes, materials of interior, and interior materials of vehicles because it has soft texture and luxurious look characteristic of the leather.

The matter to be printed is not particularly limited, and plain paper, glossy paper, special paper, and cloth can be used.

In one embodiment of the present disclosure, a difference (A−B) between a friction coefficient A on a surface of the leather and a friction coefficient B on a surface of the ink film is preferably 0.5 or less, more preferably 0.3 or less. When the difference between friction coefficients is 0.5 or less, it is possible to obtain a printed matter excellent in scratch resistance and texture.

Here, the friction coefficient can be measured using, for example, a portable tactile meter (HEIDON, model: TRIBOGEAR Type: 33, available from Shinto Scientific Co., Ltd.). The leather or the ink film is cut into a piece having a size of 25 mm×10 mm using a cutter, and is placed on the device. Then, the piece is rubbed with the inner surface of a forefinger to measure the friction coefficient under the following conditions.

<Measurement Conditions>

Analog voltage output: 2.5 V

Maximum frictional force: 2000 gf (=5 V)

Rubbing rate: 7 cm/sec

Threshold value: 4 gf

Minimum width: 0.2 s

The ink of the present disclosure includes a coloring material, an organic solvent, and a resin, and further includes other components if necessary.

<Coloring Material>

The coloring material has no particular limit. For example, pigments and dyes are suitable.

The pigment includes inorganic pigments and organic pigments. These can be used alone or in combination. In addition, it is possible to use a mixed crystal.

As the pigments, for example, black pigments, yellow pigments, magenta pigments, cyan pigments, white pigments, green pigments, orange pigments, gloss pigments of gold, silver, etc., and metallic pigments can be used.

As the inorganic pigments, in addition to titanium oxide, iron oxide, calcium oxide, barium sulfate, aluminum hydroxide, barium yellow, cadmium red, and chrome yellow, carbon black manufactured by known methods such as contact methods, furnace methods, and thermal methods can be used.

As the organic pigments, it is possible to use azo pigments, polycyclic pigments (phthalocyanine pigments, perylene pigments, perinone pigments, anthraquinone pigments, quinacridone pigments, dioxazine pigments, indigo pigments, thioindigo pigments, isoindolinone pigments, and quinophthalone pigments, etc.), dye chelates (basic dye type chelates, acid dye type chelates, etc.), nitro pigments, nitroso pigments, and aniline black. Of these pigments, pigments having good affinity with solvents are preferable. Also, hollow resin particles and inorganic hollow particles can be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 5, 17, 22, 23, 31, 38, and 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63; C.I. Pigment Green 1, 4, 7, 8, 10, 17, 18, and 36.

The type of dye is not particularly limited and includes, for example, acidic dyes, direct dyes, reactive dyes, and basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the coloring material in ink is preferably from 0.1 to 15 percent by mass and more preferably from 1 to 10 percent by mass in terms of enhancement of image density, fixability, and discharging stability.

To obtain the ink, the pigment is dispersed by, for example, preparing a self-dispersible pigment by introducing a hydrophilic functional group into the pigment, coating the surface of the pigment with resin, or using a dispersant.

To prepare a self-dispersible pigment by introducing a hydrophilic functional group into a pigment, for example, it is possible to add a functional group such as sulfone group and carboxyl group to the pigment (e.g., carbon) to disperse the pigment in water.

To coat the surface of the pigment with resin, the pigment is encapsulated by micro-capsules to make the pigment dispersible in water. This can be referred to as a resin-coated pigment. In this case, the pigment to be added to ink is not necessarily coated with resin. Pigments partially or wholly uncovered with resin may be dispersed in the ink unless the pigments have an adverse impact. Among them, a resin-coated pigment is preferable in terms of fixability, storage stability, and discharge reliability of the ink. To use a dispersant, for example, a known dispersant of a small molecular weight type or a high molecular weight type represented by a surfactant is used to disperse the pigments in ink.

As the dispersant, it is possible to use, for example, anionic surfactants, cationic surfactants, nonionic surfactants, amphoteric surfactants, etc. depending on the pigments. Also, a nonionic surfactant (RT-100, manufactured by TAKEMOTO OIL & FAT CO., LTD.) and a formalin condensate of naphthalene sodium sulfonate are suitable as dispersants.

These dispersants can be used alone or in combination.

<Pigment Dispersion>

The ink can be obtained by mixing a pigment with materials such as water and organic solvent. It is also possible to mix a pigment with water, a dispersant, etc., first to prepare a pigment dispersion and thereafter mix the pigment dispersion with materials such as water and organic solvent to manufacture ink.

The pigment dispersion is obtained by mixing and dispersing water, pigment, pigment dispersant, and other optional components and adjusting the particle size. It is good to use a dispersing device for dispersion.

The particle diameter of the pigment in the pigment dispersion has no particular limit. For example, the maximum frequency in the maximum number conversion is preferably from 20 to 500 nm and more preferably from 20 to 150 nm to improve dispersion stability of the pigment and ameliorate the discharging stability and image quality such as image density. The particle diameter of the pigment can be measured using a particle size analyzer (Nanotrac Wave-UT151, manufactured by MicrotracBEL Corp).

In addition, the proportion of the pigment in the pigment dispersion is not particularly limited and can be suitably selected to suit a particular application. In terms of improving discharging stability and image density, the content is preferably from 0.1 to 50 percent by mass and more preferably from 0.1 to 30 percent by mass.

During the production, coarse particles are optionally filtered off with a filter, a centrifuge, etc. preferably followed by degassing.

<Organic Solvent>

There is no specific limitation on the type of the organic solvent used in the present disclosure. For example, water-soluble organic solvents are suitable. Specific examples thereof include, but are not limited to, polyols, ethers such as polyol alkylethers and polyol arylethers, nitrogen-containing heterocyclic compounds, amide compounds, amines, and sulfur-containing compounds. Among them, inclusion of an amide compound is preferable because a poorly permeable or impermeable leather surface of which is treated with, for example, a resin can achieve scratch resistance and fixability. Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and petriol; polyol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrolidone, N-methyl-2-pyrolidone, N-hydroxyethyl-2-pyrolidone, 1,3-dimethyl-2-imidazolidinone, ε-caprolactam, and γ-butyrolactone; amide compounds represented by General Formula (1) below; amines such as monoethanolamine, diethanolamine, and triethylamine; sulfur-containing compounds such as dimethyl sulfoxide, sulfolane, and thiodiethanol; propylene carbonate, and ethylene carbonate.

Since the water-soluble organic solvent serves as a humectant and also imparts a good drying property, it is preferable to use an organic solvent having a boiling point of 250 degrees C. or lower.

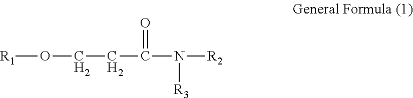

Here, in the General Formula (1), R₁, R₂, and R₃ each independently represent a hydrocarbon group having 1 or more but 8 or less carbon atoms.

The hydrocarbon group is not particularly limited, so long as the number of carbon atoms is 1 or more but 8 or less. Examples of the hydrocarbon group include straight-chain alkyl groups, branched-chain alkyl groups, and cyclic alkyl groups.

Examples of the alkyl group include a methyl group, an ethyl group, a propyl group, a butyl group, an isopropyl group, an isobutyl group, a pentyl group, a hexyl group, a heptyl group, an ethylhexyl group, an octyl group, a cyclopropyl group, a cyclobutyl group, a cyclopentyl group, and a cyclohexyl group.

Examples of the amide compound represented by the General Formula (1) include 3-methoxy-N,N-dimethylpropionamide and 3-butoxy-N,N-dimethylpropionamide.

Polyol compounds having eight or more carbon atoms and glycol ether compounds are also suitable.

Specific examples of the polyol compounds having eight or more carbon atoms include, but are not limited to, 2-ethyl-1,3-hexanediol and 2,2,4-trimethyl-1,3-pentanediol.

Specific examples of the glycolether compounds include, but are not limited to, polyol alkylethers such as ethyleneglycol monoethylether, ethyleneglycol monobutylether, diethylene glycol monomethylether, diethyleneglycol monoethylether, diethyleneglycol monobutylether, tetraethyleneglycol monomethylether, propyleneglycol monoethylether; and polyol arylethers such as ethyleneglycol monophenylether and ethyleneglycol monobenzylether.

<Resin>

The type of the resin contained in the ink is not particularly limited and may be appropriately selected depending on the intended purpose. Specific examples thereof include, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins. These may be used alone or in combination. Particles of such resins may be also used. It is possible to mix a resin emulsion in which the resin particles are dispersed in water serving as a dispersion medium with materials such as a coloring agent and an organic solvent to obtain ink. The resin particle can be synthesized or is available on the market. As the resin particle, an appropriately synthesized product or a commercially available product may be used.

Among these resins, a urethane resin or an acrylic resin is preferable in terms of scratch resistance and fixability on a leather.

The proportion of the resin is not particularly limited and can be suitably selected to suit to a particular application. Relative to the total amount of the ink, it is preferably from 1 to 30 percent by mass in terms of fixability and storage stability of the ink, and more preferably 3 percent by mass or more but 15 percent by mass or less in terms of fixability and texture.

The particle diameter of the solid portion in ink is not particularly limited and may be appropriately selected depending on the intended purpose. For example, the maximum frequency in the maximum number conversion is preferably from 20 to 1,000 nm and more preferably from 20 to 150 nm to ameliorate the discharging stability and image quality such as image density. The solid portion includes resin particles, particles of pigments, etc. The particle diameter of the solid portion can be measured by using a particle size analyzer (Nanotrac Wave-UT151, manufactured by MicrotracBEL Corp).

<Additive>

Ink may further optionally contain water, a surfactant, a defoaming agent, a preservative and fungicide, a corrosion inhibitor, a pH regulator, etc.

—Water—

Examples of the water include: pure water such as ion-exchanged water, ultrafiltrated water, reverse osmotic water, and distilled water; and ultrapure water.

The proportion of water in the ink is not particularly limited and may be appropriately selected depending on the intended purpose. In terms of the drying property and discharging reliability of the ink, the proportion is preferably from 10 to 90 percent by mass and more preferably from 20 to 60 percent by mass.

—Surfactant—

Examples of the surfactant are silicone-based surfactants, fluorosurfactants, amphoteric surfactants, nonionic surfactants, anionic surfactants, etc.

The silicone-based surfactant has no specific limit and can be suitably selected to suit to a particular application. Of these, preferred are silicone-based surfactants which are not decomposed even in a high pH environment. Specific examples thereof include, but are not limited to, side-chain-modified polydimethylsiloxane, both end-modified polydimethylsiloxane, one-end-modified polydimethylsiloxane, and side-chain-both-end-modified polydimethylsiloxane. A silicone-based surfactant having a polyoxyethylene group or a polyoxyethylene polyoxypropylene group as a modified group is particularly preferable because such an agent demonstrates good characteristics as an aqueous surfactant. It is possible to use a polyether-modified silicone-based surfactant as the silicone-based surfactant. A specific example thereof is a compound in which a polyalkylene oxide structure is introduced into the side chain of the Si site of dimethyl silooxane.

Specific examples of the fluoro surfactants include, but are not limited to, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain. These are particularly preferable because they do not foam easily. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain and salts of polyoxyalkylene ether polymers having a perfluoroalkyl ether group in its side chain. Counter ions of salts in these fluorine-based surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides, etc.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactants is not particularly limited and may be appropriately selected depending on the intended purpose. Specific examples thereof include, but are not limited to, side-chain-modified polydimethyl siloxane, both end-modified polydimethylsiloxane, one-end-modified polydimethylsiloxane, and side-chain-both-end-modified polydimethylsiloxane. In particular, a polyether-modified silicone-based surfactant having a polyoxyethylene group or a polyoxyethylene polyoxypropylene group as a modified group is particularly preferable because such a surfactant demonstrates good characteristics as an aqueous surfactant.

Any suitably synthesized surfactant and any product thereof available on the market is suitable. Products available on the market are obtained from Byc Chemie Japan Co., Ltd., Shin-Etsu Silicone Co., Ltd., Dow Corning Toray Co., Ltd., etc., NIHON EMULSION Co., Ltd., Kyoeisha Chemical Co., Ltd., etc.

The polyether-modified silicon-containing surfactant is not particularly limited and may be appropriately selected depending on the intended purpose. For example, a compound in which the polyalkylene oxide structure represented by the following General Formula (S-1) is introduced into the side chain of the Si site of dimethyl polysiloxane.

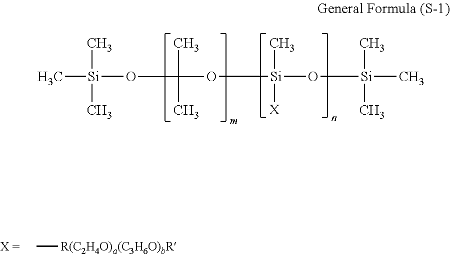

In the General Formula (S-1), “m”, “n”, “a”, and “b” each independently represent an integer, R represents an alkylene group, and R′ represents an alkyl group.

Specific examples of polyether-modified silicone-based surfactants include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co., Ltd.), BYK-33 and BYK-387 (both manufactured by BYK Japan KK.), and TSF4440, TSF4452, and TSF4453 (all manufactured by Momentive Performance Materials Inc.).

A fluorosurfactant in which the number of carbon atoms replaced with fluorine atoms is from 2 to 16 is preferable and, 4 to 16, more preferable.

Specific examples of the fluorosurfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain.

Of these, polyoxyalkylene ether polymer compounds having a perfluoroalkyl ether group in its side chain are preferable because they do not foam easily and the fluorosurfactant represented by the following General Formula (F-1) or General Formula (F-2) is more preferable.

CF₃CF₂(CF₂CF₂)ₘ—CH₂CH₂O(CH₂CH₂O)ₙH (General Formula (F-1))

In a compound represented by the General Formula (F-1), “m” is preferably 0 or an integer of from 1 to 10 and “n” is preferably 0 or an integer of from 1 to 40, in order to impart water solubility.

CₙF₂ₙ₊₁−CH₂CH(OH)CH₂—O—(CH₂CH₂O)ₐ—Y (General Formula (F-2))

In the General Formula (F-2), Y represents H, CₙF₂ₙ₊₁, where “n” is an integer of from 1 to 6, H₂CH(OH)CH₂—CₙF₂₊₁, where n represents an integer of from 4 to 6, or CₚH₂ₚ₊₁, where p represents an integer of from 1 to 19. “a” represents an integer of from 4 to 14.

Products available on the market may be used as the fluorosurfactant.

Specific examples of the products available on the market include, but are not limited to, SURFLON S-111, SURFLON S-112, SURFLON S-113, SURFLON S-121, SURFLON S-131, SURFLON S-132, SURFLON S-141, and SURFLON S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION); ZONYL (trademark) TBS, FSP, FSA, FSN-100, FSN, FSO-100, FSO, FS-300, UR, CAPSTONE (registered trademark) FS-30, FS-31, FS-3100, FS-34, FS-35 (all manufactured by The Chemours Company); FT-110, FT-250, FT-251, FT-4005, FT-150, and FT-400SW (all manufactured by NEOS COMPANY LIMITED); POLYFOX PF-136A, PF-156A, PF-151N, PF-154, PF-159 (manufactured by OMNOVA SOLUTIONS INC.), and UNIDYNE DSN-403N (manufactured by DAIKIN INDUSTRIES). Of these, FS-3100, FS-34, and FS-300 (all manufactured by Chemours), FT-110, FT-250, FT-251, FT-4005, FT-150, and FT-400SW (all manufactured by NEOS COMPANY LIMITED), PolyFox PF-151N (manufactured by OMNOVA SOLUTIONS INC.), and UNIDYNE DSN-403N (manufactured by DAIKIN INDUSTRIES) are particularly preferable in terms of good printing quality, coloring in particular, and improvement on permeation, wettability, and uniform dying property to paper.

The proportion of the surfactant in ink is not particularly limited and may be appropriately selected depending on the intended purpose. It is preferably from 0.001 to 5 percent by mass and more preferably from 0.05 to 5 percent by mass ink in terms of excellent wettability and discharging stability and improvement on image quality.

—Defoaming Agent—

The defoaming agent has no particular limit. For example, silicon-based defoaming agents, polyether-based defoaming agents, and aliphatic acid ester-based defoaming agents are suitable. These can be used alone or in combination. Of these, silicone-based defoaming agents are preferable to easily break foams.

—Preservatives and Fungicides—

The preservatives and fungicides are not particularly limited. A specific example is 1,2-benzisothiazoline-3-on.

—Corrosion Inhibitor—

The corrosion inhibitor has not particular limit. Examples thereof are acid sulfite and sodium thiosulfate.

—pH Regulator—

The pH regulator has no particular limit. It is preferable to adjust the pH to 7 or higher. Specific examples thereof include, but are not limited to, amines such as diethanol amine and triethanol amine.

The property of the ink is not particularly limited and may be appropriately selected depending on the intended purpose. For example, viscosity, surface tension, pH, etc, are preferably in the following ranges.

The viscosity of the ink at 25 degrees C. is preferably from 5 to 30 mPa·s and more preferably from 5 to 25 mPa·s to improve print density and text quality and obtain good dischargeability. The viscosity can be measured by, for example, a rotatory viscometer (RE-80L, manufactured by TOKI SANGYO CO., LTD.). The measuring conditions are as follows:

Standard cone rotor (1°34′×R24)

Sample liquid amount: 1.2 mL

Number of rotations: 50 rotations per minute (rpm)

25 degrees C.

Measuring time: three minutes

The surface tension of the ink is preferably 35 mN/m or less and more preferably 32 mN/m or less at 25 degrees C. in terms that the ink is suitably levelized on a print medium and the drying time of the ink is shortened.

The pH of the ink is preferably from 7 to 12 and more preferably from 8 to 11 in terms of prevention of corrosion of metal materials contacting the ink.

The coloring of the ink of the present disclosure is not particularly limited and may be appropriately selected depending on the intended purpose. Examples of the coloring include yellow, magenta, cyan, black, and white.

(Ink Set)

The ink set of the present disclosure is an ink set used for a leather as a matter to be printed. The ink set includes at least two inks selected from the group consisting of a cyan ink, a magenta ink, a yellow ink, a black ink, and a white ink.

The at least two inks selected from the group consisting of the cyan ink, the magenta ink, the yellow ink, the black ink, and the white ink each include a coloring material, a resin, and an organic solvent.

A maximum tensile stress of an ink film formed of the ink is 2 N/mm² or more.

When an ink set including two or more inks in combination is used for recording, a multicolor image can be recorded. When an ink set including all the colors in combination is used for recording, a full color image can be recorded. The white ink is suitable for undercoating on a color image.

(Printed Matter)

A printed matter of the present disclosure includes: a leather; and an ink film on the leather. The ink film includes a resin and a coloring material. A maximum tensile stress of the ink film is 2 N/mm² or more.

A difference (A−B) between a friction coefficient A on a surface of the leather and a friction coefficient B on a surface of the ink film formed on the leather is preferably 0.5 or less.

The printed matter of the present disclosure is excellent in scratch resistance and is not deteriorated in texture such as touch of a leather even when a leather is used as a matter to be printed.

A method for applying the ink is not particularly limited and may be appropriately selected depending on the intended purpose. Examples of the method include the inkjet method, the blade coating method, the gravure coating method, the bar coating method, the roll coating method, the dip coating method, the curtain coating method, the slide coating method, the die coating method, and the spray coating method. Among them, the inkjet method is preferable.

(Printing Device and Printing Method)

The ink of the present disclosure can be suitably applied to various printing devices employing an inkjet printing method such as printers, facsimile machines, photocopiers, multifunction peripherals (serving as a printer, a facsimile machine, and a photocopier), and 3D model manufacturing devices (3D printers, additive manufacturing device).

In the present disclosure, the printing device and the printing method represent a device capable of discharging ink, various processing fluids, etc. to a print medium and a method for printing an image on the print medium using the device. The print medium means an article to which the ink or the various processing fluids can be attached at least temporarily. In the present disclosure, a leather is suitable.

The printing device may further optionally include a device relating to feeding, transferring, and ejecting the print medium and other devices referred to as a pre-processing device, a post-processing device, etc. in addition to the head portion to discharge the ink.

The printing device and the printing method may further optionally include a heater for use in the heating process and a drier for use in the drying process. For example, the heating device and the drying device heat and dry the top surface and the bottom surface of a print medium having an image. The heating device and the drying device are not particularly limited. For example, a fan heater and an infra-red heater can be used. The print medium can be heated and dried before, during, and after printing. The heating temperature is preferably 40 degrees Celsius or more but 120 degrees Celsius or less, more preferably 60 degrees Celsius or more but 120 degrees Celsius or less in terms of scratch resistance and fixability, still more preferably 60 degrees Celsius or more but 90 degrees Celsius or less in order to prevent flexibility of a leather from being deteriorated.

In addition, the printing device and the printing method are not limited to those producing merely meaningful visible images such as texts and figures with the ink. For example, the printing device and the printing method can produce patterns like geometric design and 3D images.

In addition, the printing device includes both a serial type device in which the liquid discharging head is caused to move and a line type device in which the liquid discharging head is not moved, unless otherwise specified.

Furthermore, in addition to the desktop type, this printing device includes a wide type printing device capable of printing images on a large print medium such as A0, a continuous printer capable of using continuous paper wound up in a roll form as print media.

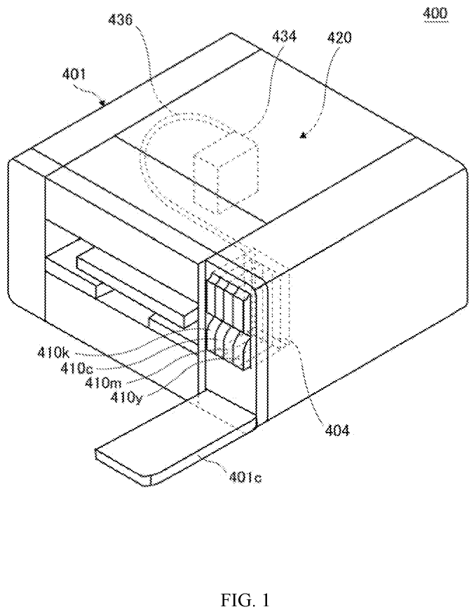

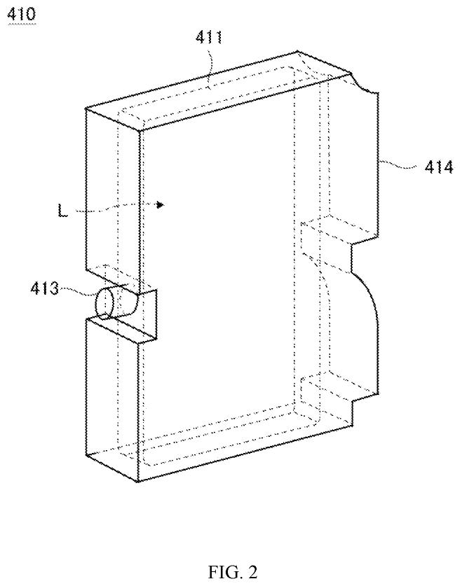

The printing device of the present disclosure is described with reference to FIG. 1 and FIG. 2. FIG. 1 is a perspective explanatory view illustrating the image printing device. FIG. 2 is a perspective explanatory view illustrating the main tank. An image forming apparatus 400 as an example of the printing device is a serial type image forming apparatus. A mechanical unit 420 is disposed in an exterior 401 of the image forming apparatus 400. Each ink accommodating unit (ink container) 411 of each main tank 410 (410k, 410c, 410m, and 410y) for each color of black (K), cyan (C), magenta (M), and yellow (Y) is made of a packing member such as aluminum laminate film. The ink container 411 is accommodated in a plastic housing unit 414. As a result, the main tank 410 is used as an ink cartridge of each color.

A cartridge holder 404 is disposed on the rear side of the opening when a cover 401c is opened. The cartridge holder 404 is detachably attached to the main tank 410. As a result, each ink discharging outlet 413 of the main tank 410 is communicated with a discharging head 434 for each color via a supplying tube 436 for each color so that the ink can be discharged from the discharging head 434 to a print medium.

Moreover, image forming, recording, printing, etc. in the present disclosure represent the same meaning.

The recording medium, media, and matter to be printed represent the same meaning.

### EXAMPLES

Examples of the present disclosure will be described hereinafter. However, the present disclosure should not be construed as being limited to these Examples.

### Preparation Example 1 of Pigment Dispersion Liquid

<Preparation of Black Pigment Dispersion Liquid A>

The following raw materials were pre-mixed and were subjected to circulation dispersion with a disk-type bead mill (KDL type, obtained from Shinmaru Enterprises Corporation, media used: zirconia balls with a diameter of 0.3 mm) for 7 hours, to obtain a black pigment dispersion liquid A.

<Formulation>

Carbon black pigment (product name: MONARCH 800, obtained from Cabot Corporation): 15 parts by mass

Anionic surfactant (PIONINE A-51-B, obtained from Takemoto Oil & Fat Co., Ltd.): 2 parts by mass

Ion-exchanged water: 83 parts by mass

### Preparation Example 2 of Pigment Dispersion Liquid

<Preparation of Cyan Pigment Dispersion Liquid A>

A cyan pigment dispersion liquid A was obtained in the same manner as in Preparation Example 1 of pigment dispersion liquid, except that the carbon black pigment used in Preparation Example 1 of pigment dispersion liquid was changed to Pigment blue 15:3 (product name: LIONOL BLUE FG-7351 obtained from Toyo Ink Co., Ltd.).

### Preparation Example 3 of Pigment Dispersion Liquid

<Preparation of Magenta Pigment Dispersion Liquid A>

A magenta pigment dispersion liquid A was obtained in the same manner as in Preparation Example 1 of pigment dispersion liquid, except that the carbon black pigment used in Preparation Example 1 of pigment dispersion liquid was changed to Pigment red 122 (product name: TONER MAGENTA E002 obtained from Clamant (Japan) K.K.).

### Preparation Example 4 of Pigment Dispersion Liquid

<Preparation of Yellow Pigment Dispersion Liquid A>

A yellow pigment dispersion liquid A was obtained in the same manner as in Preparation Example 1 of pigment dispersion liquid, except that the carbon black pigment used in Preparation Example 1 of pigment dispersion liquid was changed to a Pigment yellow 74 (product name: FAST YELLOW 531, obtained from Dainichiseika Color & Chemicals Mfg. Co., Ltd.).

### Preparation Example 5 of Pigment Dispersion Liquid

—Synthesis of Polymer A—

Styrene (11.2 g), acrylic acid (2.8 g), lauryl methacrylate (12 g), polyethylene glycol methacrylate (4 g), styrene macromer (4 g), and mercaptoethanol (0.4 g) were mixed and were heated to 65 degrees Celsius.

Next, a mixture solution of styrene (100.8 g), acrylic acid (25.2 g), lauryl methacrylate (108 g), polyethylene glycol methacrylate (36 g), hydroxylethyl methacrylate (60 g), styrene macromer (36 g), mercaptoethanol (3.6 g), azobismethylvaleronitrile (2.4 g), and methyl ethyl ketone (18 g) was added dropwise to the flask over 2.5 hours.

After the dropping, a mixture solution of azobismethylvaleronitrile (0.8 g) and methyl ethyl ketone (18 g) was added dropwise to the flask over 0.5 hours.

The resultant was aged at 65 degrees Celsius for 1 hour, and azobismethylvaleronitrile (0.8 g) was added thereto, followed by aging for 1 hour.

After the reaction completed, methyl ethyl ketone (364 g) was added to the flask, to obtain a polymer solution A (800 g) with a solid content concentration of 50% by mass.

—Preparation of Black Pigment Dispersion Liquid B—

Then, the aforementioned polymer solution A (28 g), carbon black (obtained from Cabot Corporation, Black Pearls 1000) (42 g), 1 mol/L of an aqueous potassium hydroxide solution (13.6 g), methyl ethyl ketone (20 g), and water (13.6 g) were sufficiently stirred and were kneaded using a roll mill.

The paste obtained was added to pure water (200 g), followed by sufficient stirring. Then, methyl ethyl ketone was removed by an evaporator, and the resultant was subjected to pressure filtration using a polyvinylidene fluoride membrane filter with an average pore diameter of 5 μm. An amount of water was adjusted so that a solid content concentration would be 20% to obtain styrene-acrylic resin-coated black pigment dispersion liquid B with a solid content concentration of 20% by mass.

### Preparation Example 6 of Pigment Dispersion Liquid

<Preparation of Cyan Pigment Dispersion Liquid B>

Styrene-acrylic resin-coated cyan pigment dispersion liquid B with a solid content concentration of 20% by mass was obtained in the same manner as in Preparation Example 5 of pigment dispersion liquid except that carbon black was changed to Pigment Blue 15:4 (obtained from SENSIENT, SMART Cyan 3154BA).

### Preparation Example 7 of Pigment Dispersion Liquid

<Preparation of Magenta Pigment Dispersion Liquid B>

Styrene-acrylic resin-coated magenta pigment dispersion liquid B with a solid content concentration of 20% by mass was obtained in the same manner as in Preparation Example 5 of pigment dispersion liquid except that carbon black was changed to Pigment Red 122 (obtained from Sun Chemical, Pigment Red 122).

### Preparation Example 8 of Pigment Dispersion Liquid

<Preparation of Yellow Pigment Dispersion Liquid B>

Styrene-acrylic resin-coated yellow pigment dispersion liquid B with a solid content concentration of 20% by mass was obtained in the same manner as in Preparation Example 5 of pigment dispersion liquid except that carbon black was changed to Pigment yellow 74 (obtained from SENSIENT, SMART Yellow 3074BA).

### Preparation Example 1 of Polyurethane Resin Emulsion

<Preparation of Polyester-Based Urethane Resin Emulsion>

In a container that had been equipped with a thermometer, a nitrogen gas introducing tube, and a stirrer and had been purged with nitrogen, a double amount of polyester polyol (product name: POLYLITE OD-X-2251, obtained from DIC Corporation, average molecular weight: 2,000) (200.4 g), 2,2-dimethylolpropionic acid (15.7 g), isophorone diisocyanate (48.0 g), methyl ethyl ketone (77.1 g) as an organic solvent, and DMTDL (dibutyltin dilaurate) (0.06 g) as a catalyst were allowed to react. After the reaction was continued for 4 hours, methyl ethyl ketone (30.7 g) as a dilution solvent was supplied thereto, followed by continuing the reaction. At the time when an average molecular weight of the reaction product reached a range of from 20,000 through 60,000, methanol (1.4 g) was added thereto, to complete the reaction. As a result, an organic solvent solution of a urethane resin was obtained.

When 48% by mass aqueous potassium hydroxide solution (13.4 g) was added to the organic solvent solution of the urethane resin, a carboxyl group in the urethane resin was neutralized. Then, water (715.3 g) was added thereto, the resultant was sufficiently stirred and aged, and the solvent was removed to obtain a polyester-based urethane resin emulsion with a solid content concentration of 30% by mass.

A minimum filming temperature (MFT) of the obtained polyester-based urethane resin emulsion measured using “filming temperature tester” (obtained from IMOTO MACHINERY CO., LTD.) was 74 degrees Celsius.

### Example 1

<Production of Ink A>

Ion-exchanged water was added to the following ink formulation in such an amount that a total of the following ink formulation would reach 100 parts by mass, followed by mixing and stirring. Then, the resultant was filtrated through a filter having an average pore diameter of 5 μm (obtained from Sartorius, Minisart) to obtain ink A.

<Ink Formulation>

The aforementioned black pigment dispersion liquid B (resin-coated): 20 parts by mass

Acrylic resin (1) (Mowinyl 6800, obtained from Japan Coating Resin Corporation, solid content concentration: 45% by mass): 9.0 parts by mass

Triton HW1000 (obtained from The Dow Chemical Company): 1.0 part by mass

BYK348 (obtained from BYK, silicone surfactant): 0.2 parts by mass

1,2-Propanediol (product name: propylene glycol, obtained from ADEKA Corporation): 4 parts by mass

1,3-Propanediol (obtained from Dupont): 2 parts by mass

3-Methyl-1,5-pentanediol (product name: MPD, obtained from Kuraray Co., Ltd.):

2 parts by mass

3-Methoxy-3-methyl-1-butanol (product name: Solfit, obtained from Kuraray Co., Ltd.): 5 parts by mass

3-Methoxy-N,N-dimethylpropionamide (product name: EQUAMIDE M100, obtained from Idemitsu Kosan Co., Ltd.): 10 parts by mass

PROXEL LV (obtained from Avecia, preservative and fungicide): 0.1 parts by mass

Ion-exchanged water: balance (total: 100 parts by mass)

### Examples 2 to 10 and Comparative Examples 1 to 3

<Production of Inks B to M>

Ink B to ink M were produced in the same manner as in Example 1 except that the ink formulation of Example 1 was changed to each ink formulation presented in Table 1 to Table 3. Note that, the contents of resins in Table 1 to Table 3 are represented by a solid content concentration.

TABLE 1

| | | Ex. 1 | Ex. 2 | Ex. 3 | Ex. 4 | Ex. 5 |
|---|---|---|---|---|---|---|
| | | Ink A | Ink B | Ink C | Ink D | Ink E |
| Coloring | Black pigment dispersion liquid A | | | | | |
| material | Black pigment dispersion liquid B (resin-coated) | 20 | | | | 20 |
| | Cyan pigment dispersion liquid A | | | | 20 | |
| | Cyan pigment dispersion liquid B (resin-coated) | | 20 | | | |
| | Magenta pigment dispersion liquid A | | | | | |
| | Magenta pigment dispersion liquid B (resin-coated) | | | 20 | | |
| | Yellow pigment dispersion liquid A | | | | | |
| | Yellow pigment dispersion liquid B (resin-coated) | | | | | |
| Resin | Polyurethane resin (1) SUPERFLEX 300 | | | 3.0 | | |
| | Polyurethane resin (2) (MFT: 74° C.) | | 5.0 | | 7.2 | |
| | Polyurethane resin (3) W6110 | 9.0 | | | | 0.3 |
| | Acrylic resin (1) Mowinyl 6800 | | | | | 2.5 |
| | Acrylic resin (2) Mowinyl 6969D | | | 5.0 | | |
| | Acrylic resin (3) Mowinyl 8750 | | | | 7.5 | |
| | Fluororesin AF1600 | | | | | |
| Surfactant | Surfactant (1) Triton HW1000 | 1.0 | 1.0 | 1.0 | 1.0 | 1.0 |
| | Surfactant (2) BYK348 | 0.2 | 0.2 | 0.2 | 0.2 | 0.2 |
| Organic | 1,2-Propanediol | 4 | | 6 | 5 | |
| solvent | 1,3-Propanediol | 2 | | | 3 | 5 |
| | 1,3-Butanediol | | 5 | | | |
| | 2-Ethyl-1,3-hexanediol | | | 2 | | 3 |
| | 3-Methyl-1,5-pentanediol | 2 | 3 | | | |
| | 3-Methoxy-1-butanol | | 5 | | 3 | 5 |
| | 3-Methoxy-3-methyl-1-butanol | 5 | | 5 | | |
| | 3-Methoxy-N,N-dimethylpropionamide | 10 | | 4 | 3 | 10 |
| | 3-Butoxy-N,N-dimethylpropionamide | | 8 | 4 | 5 | |
| Preservative | PROXEL LV (obtained from Avecia) | 0.1 | 0.1 | 0.1 | 0.1 | 0.1 |
| and fungicide | | | | | | |
| Water | Highly pure water | Balance | Balance | Balance | Balance | Balance |

| | | | | | |
|---|---|---|---|---|---|
| Total (% by mass) | 100 | 100 | 100 | 100 | 100 |

TABLE 2

| | | Ex. 6 | Ex. 7 | Ex. 8 | Ex. 9 | Ex. 10 |
|---|---|---|---|---|---|---|
| | | Ink F | Ink G | Ink H | Ink I | Ink J |
| Coloring | Black pigment dispersion liquid A | | | | 20 | |
| material | Black pigment dispersion liquid B (resin-coated) | | 20 | | | |
| | Cyan pigment dispersion liquid A | | | | | |
| | Cyan pigment dispersion liquid B (resin-coated) | | | | | |
| | Magenta pigment dispersion liquid A | | | 20 | | |
| | Magenta pigment dispersion liquid B (resin-coated) | | | | | |
| | Yellow pigment dispersion liquid A | 20 | | | | |
| | Yellow pigment dispersion liquid B (resin-coated) | | | | | 20 |
| Resin | Polyurethane resin (1) SUPERFLEX 300 | 5.0 | | 2.0 | | |
| | Polyurethane resin (2) (MFT: 74° C.) | | | 6.0 | | |
| | Polyurethane resin (3) W6110 | 11.0 | | | | |
| | Acrylic resin (1) Mowinyl 6800 | | | | | |
| | Acrylic resin (2) Mowinyl 6969D | | | | | 2.5 |
| | Acrylic resin (3) Mowinyl 8750 | | | | | |
| | Fluororesin AF1600 | | 3.3 | | 18.0 | |
| Surfactant | Surfactant (1) Triton HW1000 | 1.0 | 1.0 | 1.0 | 1.0 | 1.0 |
| | Surfactant (2) BYK348 | 0.2 | 0.2 | 0.2 | 0.2 | 0.2 |
| Organic | 1,2-Propanediol | 4 | 4 | | | |
| solvent | 1,3-Propanediol | | | 2 | 7 | |
| | 1,3-Butanediol | | | 4 | | 6 |
| | 2-Ethyl-1,3-hexanediol | | 4 | | 2 | |
| | 3-Methyl-1,5-pentanediol | | | 4 | | 5 |
| | 3-Methoxy-1-butanol | | 6 | 6 | | |
| | 3-Methoxy-3-methyl-1-butanol | 2 | | | 2 | 7 |
| | 3-Methoxy-N,N-dimethylpropionamide | | 8 | | | |
| | 3-Butoxy-N,N-dimethylpropionamide | 10 | | | 6 | |
| Preservative | PROXEL LV (obtained from Avecia) | 0.1 | 0.1 | 0.1 | 0.1 | 0.1 |
| and fungicide | | | | | | |
| Water | Highly pure water | Balance | Balance | Balance | Balance | Balance |

| | | | | | |
|---|---|---|---|---|---|
| Total (% by mass) | 100 | 100 | 100 | 100 | 100 |

TABLE 3

| | | Comp. | Comp. | Comp. |
|---|---|---|---|---|
| | | Ex. 1 | Ex. 2 | Ex. 3 |
| | | Ink K | Ink L | Ink M |
| Coloring material | Black pigment dispersion liquid A | | | |
| | Black pigment dispersion liquid B (resin-coated) | | | |
| | Cyan pigment dispersion liquid A | | 20 | |
| | Cyan pigment dispersion liquid B (resin-coated) | | | |
| | Magenta pigment dispersion liquid A | | | |
| | Magenta pigment dispersion liquid B (resin-coated) | | | 20 |
| | Yellow pigment dispersion liquid A | | | |
| | Yellow pigment dispersion liquid B (resin-coated) | 20 | | |
| Resin | Polyurethane resin (1) SUPERFLEX 300 | | | |
| | Polyurethane resin (2) (MFT: 74° C.) | 2.0 | | |
| | Polyurethane resin (3) W6110 | | | |
| | Acrylic resin (1) Mowinyl 6800 | | | |
| | Acrylic resin (2) Mowinyl 6969D | | | |
| | Acrylic resin (3) Mowinyl 6750 | | | |
| | Fluororesin AF1600 | | 4.0 | |
| Surfactant | Surfactant (1) Triton HW1000 | 1.0 | 1.0 | 1.0 |
| | Surfactant (2) BYK348 | 0.2 | 0.2 | 0.2 |
| Organic solvent | 1,2-Propanediol | | 3 | 6 |
| | 1,3-Propanediol | 4 | | |
| | 1,3-Butanediol | | 3 | |
| | 2-Ethyl-1,3-hexanediol | 2 | | 3 |
| | 3-Methyl-1,5-pentanediol | | 5 | |
| | 3-Methoxy-1-butanol | 5 | 5 | 4 |
| | 3-Methoxy-3-methyl-1-butanol | | | |
| | 3-Methoxy-N,N-dimethylpropionamide | 8 | | 5 |
| | 3-Butoxy-N,N-dimethylpropionamide | | | 5 |
| Preservative and fungicide | PROXEL LV (obtained from Avecia) | 0.1 | 0.1 | 0.1 |
| Water | Highly pure water | Balance | Balance | Balance |

| | | | |
|---|---|---|---|
| Total (% by mass) | 100 | 100 | 100 |

Details of the respective components in Tables 1 to 3 are as follows.

—Resin—

Polyurethane resin (1): SUPERFLEX 300 (obtained from DKS Co. Ltd., solid content concentration: 30% by mass)

Polyurethane resin (2): Polyester-based urethane resin emulsion obtained from Preparation Example 1 of polyurethane resin emulsion (solid content concentration: 30% by mass, minimum filming temperature (MFT): 74 degrees Celsius)

Polyurethane resin (3): W6110 (obtained from Mitsui Chemicals, Inc., solid content concentration: 35% by mass)

Acrylic resin (1): Mowinyl 6800 (obtained from Japan Coating Resin Corporation, solid content concentration: 45% by mass)

Acrylic resin (2): Mowinyl 6969D (obtained from Japan Coating Resin Corporation, solid content concentration: 40% by mass)

Acrylic resin (3): Mowinyl 6750 (obtained from Japan Coating Resin Corporation, solid content concentration: 50% by mass)

Fluororesin: AF1600 (obtained from DU PONT-MITSUI FLUOROCHEMICALS COMPANY, LTD)

—Organic Solvent—

1,2-Propanediol (product name: propylene glycol, obtained from ADEKA Corporation)

1,3-Propanediol (obtained from Dupont)

1,3-Butanediol (product name: 1,3-butanediol, obtained from Daicel Corporation)

2-Ethyl-1,3-hexanediol (product name: octanediol, obtained from KH Neochem Co., Ltd.)

3-Methyl-1,5-pentanediol (product name: MPD, obtained from Kuraray Co., Ltd.)

3-Methoxy-1-butanol (product name: MB, obtained from Daicel Corporation)

3-Methoxy-3-methyl-1-butanol (product name: SOLFIT, obtained from Kuraray Co., Ltd.)

3-Methoxy-N,N-dimethylpropionamide (product name: EQUAMIDE M100, obtained from Idemitsu Kosan Co., Ltd.)

3-Butoxy-N,N-dimethylpropionamide (product name: EQUAMIDE B100, obtained from Idemitsu Kosan Co., Ltd.)

—Surfactant—

Surfactant (1): Triton HW1000, obtained from The Dow Chemical Company

Surfactant (2): BYK348, obtained from BYK, silicone surfactant

—Preservative and Fungicide—

PROXEL LV, obtained from Avecia

<Image Formation>

Each ink was loaded into an inkjet printer (apparatus name: modified device of IPSiO GXe5500, obtained from Ricoh Company, Ltd.). Then, a solid image (100% gradation) having a resolution of 600×600 dpi was printed on the following natural leather and synthetic leather as a matter to be printed by ink droplets in which the volume of one ink droplet would be 21 pL. The printed matter was allowed to pass into a hot-air drying unit at 70 degrees Celsius, followed by drying and fixing.

—Matter to be Printed—

(1) Natural leather (surface treatment was performed with an acrylic resin, cowhide, average thickness: 2 mm)

(2) Synthetic leather (surface treatment was performed with a urethane resin, average thickness: 1.2 mm)

Note that, a friction coefficient on the surface of each leather was measured in the same manner as in the following friction coefficient on surface of the following ink film.

A printed matter formed by each ink was measured for “maximum tensile stress of ink film” and “friction coefficient on surface of ink film” in the following manners. In addition, “scratch resistance” and “texture” were evaluated in the following manners. Results are presented in Table 4 to Table 6.

<Maximum Tensile Stress of Ink Film>

The maximum tensile stress of ink film was measured as follows. Ink (8 g) was added to a TEFLON (registered trademark) dish having a diameter of 50 mm and was dried in a hot-air-circulation-type thermostat bath at 70 degrees Celsius for two days, to obtain an ink film. The ink film obtained was cut into a piece having a size of 5 mm×50 mm using a cutter, and was subjected to the tensile testing under the following measurement conditions. An average thickness of the ink film, which was an average value obtained by measuring three or more portions with a micrometer, was from 0.3 mm through 0.8 mm.

<Measurement Conditions of Tensile Stress>

Device: AUTOGRAPH AG-10N, obtained from SHIMADZU CORPORATION

Load cell: 50 N

Tension speed: 150 mm/min

Distance between chucks: 4 mm

Sample width: 5 mm

<Friction Coefficient on Surface of Ink Film>

The friction coefficient on surface of ink film was measured using a portable tactile meter (HEIDON, model: TRIBOGEAR Type: 33, obtained from Shinto Scientific Co., Ltd.). The ink film was cut into a piece having a size of 25 mm×10 mm using a cutter, and was placed on the device. Then, the piece was rubbed with the inner surface of a forefinger to measure the friction coefficient on surface of ink film under the following conditions.

A difference (A−B) between a friction coefficient A on the surface of the afore-mentioned leather and a friction coefficient B on the surface of the ink film was calculated.

<Measurement Conditions>

Analog voltage output: 2.5 V

Maximum frictional force: 2000 gf (=5 V)

Rubbing rate: 7 cm/sec

Threshold value: 4 gf

Minimum width: 0.2 s

<Evaluation of Scratch Resistance>

The printed matter obtained was cut into a piece having a size of 2.5 cm×20 cm, and was placed on a rubbing fastness tester for dyed matters (model: AR-2, obtained from INTEC CO., LTD). A dried white cloth (canequim No. 3) was allowed to move forward and backward 100 times under the load of 500 g at a reciprocating rate of 30 times/min. The, the printed matter and the white cloth were observed and were evaluated for the scratch resistance based on the following evaluation criteria. Here, when the result was AA, A, or B, it can be considered to be practically usable.

—Evaluation Criteria—

AA: The leather as a base material was not exposed and almost no color was transferred to the white cloth.

A: The leather as a base material was not exposed and color was slightly transferred to the white cloth.

B: The leather as a base material was partially exposed and color was transferred to a part of the white cloth.

C: The leather as a base material was partially exposed and color was transferred to the entire white cloth.

D: Half or more of the leather as a base material was exposed.

<Evaluation of Texture>

A difference in level felt when the printed matter obtained was traced with the inner surface of a forefinger at 7 cm/sec from the non-printed portion toward the printed portion, was evaluated for texture based on the following evaluation criteria. Here, when the result was AA, A, or B, it can be considered to be practically usable.

—Evaluation Criteria—

AA: There was no difference in level at a boundary between the non-printed portion and the printed portion.

A: There was no difference in level at a boundary between the non-printed portion and the printed portion, but texture was changed.

B: There was a slight difference in level at a boundary between the non-printed portion and the printed portion.

C: A finger was stopped once at a boundary between the non-printed portion and the printed portion.

TABLE 4

| | | Ex. 1 | Ex. 2 | Ex. 3 | Ex. 4 | Ex. 5 |
|---|---|---|---|---|---|---|
| | | Ink A | Ink B | Ink C | Ink D | Ink E |
| Maximum tensile stress of ink film | | 11.3 | 10.3 | 5.2 | 4.1 | 3.4 |
| N/mm²) | | | | | | |
| Difference between friction coefficients | | 0.12 | 0.15 | 0.26 | 0.44 | 0.31 |
| (natural leather) | | | | | | |
| Difrerence between friction coefficients | | 0.15 | 0.14 | 0.23 | 0.47 | 0.3 |
| (synthetic leather) | | | | | | |
| Scratch resistance | Natural leather | AA | AA | AA | A | B |
| | Synthetic leather | AA | AA | A | A | A |
| Texture | Natural leather | AA | AA | A | B | A |
| | Synthetic leather | AA | AA | A | B | A |

TABLE 5

| | | Ex. 6 | Ex. 7 | Ex. 8 | Ex. 9 | Ex. 10 |
|---|---|---|---|---|---|---|
| | | Ink F | Ink G | Ink H | Ink I | Ink J |
| Maximum tensile stress of ink film | | 15.6 | 9.9 | 2.7 | 4.5 | 2.3 |
| (N/mm²) | | | | | | |
| Difference between friction coefficients | | 0.48 | 0.18 | 0.38 | 0.51 | 0.52 |
| (natural leather) | | | | | | |
| Difference between friction coefficients | | 0.43 | 0.23 | 0.37 | 0.54 | 0.52 |
| (synthetic leather) | | | | | | |
| Scratch resistance | Natural leather | A | B | B | B | B |
| | Synthetic 1eather | AA | B | B | B | B |
| Texture | Natural leather | B | AA | A | B | B |
| | Synthetic leather | B | A | A | B | B |

TABLE 6

| | | Comp. | Comp. | Comp. |
|---|---|---|---|---|
| | | Ex. 1 | Ex. 2 | Ex. 3 |
| | | Ink K | Ink L | Ink M |
| Maximum tensile stress of ink film (N/mm²) | | 1.4 | 1.1 | 0.2 |
| Difference between friction coefficients | | 0.33 | 0.36 | 0.55 |
| (natural leather) | | | | |
| Difference between friction coefficients | | 0.34 | 0.41 | 0.52 |
| (synthetic leather) | | | | |
| Scratch resistance | Natural leather | C | D | D |
| | Synthetic leather | C | D | D |
| Texture | Natural leather | B | B | C |
| | Synthetic leather | B | C | C |

Aspects of the present disclosure are as follows, for example.

<1> An ink used for a leather as a matter to be printed, the ink including:

a coloring material;

an organic solvent; and

a resin,

wherein a maximum tensile stress of an ink film formed of the ink is 2 N/mm² or more.

<2> The ink according to <1>,

wherein a difference (A−B) between a friction coefficient A on a surface of the leather and a friction coefficient B on a surface of the ink film is 0.5 or less.

<3> The ink according to <1> or <2>,

wherein the organic solvent includes an amide compound represented by General Formula (1) below:

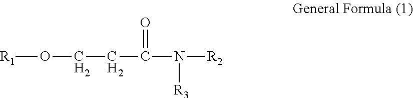

where, in the General Formula (1), R₁, R₂, and R₃ each independently represent a hydrocarbon group having 1 or more but 8 or less carbon atoms.

<4> The ink according to any one of <1> to <3>,

wherein the resin includes at least one selected from the group consisting of a urethane resin and an acrylic resin.

<5> The ink according to any one of <1> to <4>,

wherein an amount of the resin is 3% by mass or more but 15% by mass or less.

<6> The ink according to any one of <1> to <5>,

wherein the coloring material includes a resin-coated pigment.

<7> The ink according to any one of <1> to <6>,

wherein the leather is at least one selected from the group consisting of a natural leather, an artificial leather, a synthetic leather, a recycled leather, a surface-treated natural leather, a surface-treated artificial leather, a surface-treated synthetic leather, and a surface-treated recycled leather.

<8> The ink according to <7>,

wherein a surface of the leather is treated with at least one selected from the group consisting of a urethane resin and an acrylic resin.

<9> A printing method including:

applying the ink according to any one of <1> to <8> on a leather; and

drying the leather on which the ink is applied.

<10> A printing apparatus including:

a leather;

an ink applying unit configured to apply the ink according to any one of <1> to <8> on the leather; and

a drying unit configured to dry the leather on which the ink is applied.

<11> An ink set used for a leather as a matter to be printed, the ink set including

at least two inks selected from the group consisting of a cyan ink, a magenta ink, a yellow ink, a black ink, and a white ink,

wherein the at least two inks selected from the group consisting of the cyan ink, the magenta ink, the yellow ink, the black ink, and the white ink each include a coloring material, a resin, and an organic solvent, and

a maximum tensile stress of an ink film formed of the ink is 2 N/mm² or more.

<12> A printed matter including:

a leather; and

an ink film on the leather,

wherein the ink film includes a resin and a coloring material, and

a maximum tensile stress of the ink film is 2 N/mm² or more.

<13> The printed matter according to <12>,

wherein a difference (A−B) between a friction coefficient A on a surface of the leather and a friction coefficient B on a surface of the ink film formed on the leather is 0.5 or less.

The ink according to any one of <1> to <8>, the printing method according to <9>, the printing apparatus according to <10>, the ink set according to <11>, and the printed matter according to <12> or <13> can solve the existing problems in the art and can achieve the object of the present disclosure.

### REFERENCE SIGNS LIST

400: Image forming apparatus

401: Exterior of image forming apparatus

401c: Cover of image forming apparatus

404: Cartridge holder

410: Main tank

410k, 410c, 410m, 410y: Main tank for each color of black (K), cyan (C), magenta (M), and yellow (Y)

411: Ink container

413: Ink discharging outlet

414: Plastic housing unit

420: Mechanical unit

434: Discharging head

436: Supplying tube

1: An ink used for a leather as a matter to be printed, the ink comprising:
a coloring material;
an organic solvent; and
a resin,
wherein a maximum tensile stress of an ink film formed of the ink is 2 N/mm² or more.

2: The ink according to claim 1, wherein a difference (A−B) between a friction coefficient A on a surface of the leather and a friction coefficient B on a surface of the ink film is 0.5 or less.

3: The ink according to claim 1, wherein the organic solvent comprises an amide compound represented by General Formula (1) below: 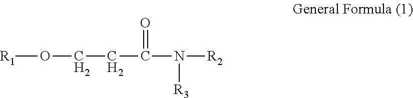
where, in the General Formula (1), R₁, R₂, and R₃ each independently represent a hydrocarbon group having 1 or more but 8 or less carbon atoms.

4: The ink according to claim 1, wherein the resin includes at least one selected from the group consisting of a urethane resin and an acrylic resin.

5: The ink according to claim 1, wherein an amount of the resin is 3% by mass or more but 15% by mass or less.

6: The ink according to claim 1, wherein the coloring material comprises a resin-coated pigment.

7: The ink according to claim 1, wherein the leather is at least one selected from the group consisting of a natural leather, an artificial leather, a synthetic leather, a recycled leather, a surface-treated natural leather, a surface-treated artificial leather, a surface-treated synthetic leather, and a surface-treated recycled leather.

8 A printing method, comprising:
applying the ink according to claim 1 on a leather; and
drying the leather on which the ink is applied.

9: A printing apparatus, comprising:
a leather;
an ink applying unit configured to apply the ink according to claim 1 on the leather; and
a drying unit configured to dry the leather on which the ink is applied.

10: An ink set used for a leather as a matter to be printed, the ink set comprising:
at least two inks selected from the group consisting of a cyan ink, a magenta ink, a yellow ink, a black ink, and a white ink,
wherein the at least two inks selected from the group consisting of the cyan ink, the magenta ink, the yellow ink, the black ink, and the white ink each include a coloring material, a resin, and an organic solvent, and
a maximum tensile stress of an ink film formed of the ink is 2 N/mm² or more.

11: A printed matter, comprising:
a leather; and
an ink film on the leather,
wherein the ink film comprises a resin and a coloring material, and a maximum tensile stress of the ink film is 2 N/mm² or more.
